(19) United States
(12) Patent Application Publication
(10) Pub. No.: US 2015/0134413 A1
(43) Pub. Date: May 14, 2015

(54) FORECASTING FOR RETAIL CUSTOMERS

(71) Applicant: International Business Machines Corporation, Armonk, NY (US)

(72) Inventors: Ajay Ashok Deshpande, Yorktown Heights, NY (US); Kimberly D. Hendrix, Yorktown Heights, NY (US); Herbert Scott McFaddin, Yorktown Heights, NY (US); Chandrasekhar Narayanaswami, Yorktown Heights, NY (US)

(21) Appl. No.: 14/502,568

(22) Filed: Sep. 30, 2014

Related U.S. Application Data
(60) Provisional application No. 61/897,901, filed on Oct. 31, 2013.

(51) Int. Cl. G06Q 30/02

(52) U.S. Cl. CPC G06Q 30/0202; G06Q 30/0205
USPC 705/7.31

(57) ABSTRACT

A method and system for retail forecasting includes accessing, from a database, retail data for past purchases of a customer at a retail entity and contextual data and generating, using a processor on a computer, at least one purchase forecasting model for a specific product for the customer.

The present application claims priority from provisional application No. 61/897,901, filed on Oct. 31, 2013, the disclosure of which is incorporated herein by reference.

### DESCRIPTION

### Field of the Invention

The present invention generally relates to retail sales forecasts by location and time period. More specifically, a customer-level sales forecast is generated, using a customer's previous shopping record and taking into account contextual data related to the customer, and the customer's shopping behavior is monitored and an alert to take action is generated when actual sales at a retail store by the customer differ from the forecast over a predetermined time period.

### BACKGROUND OF THE INVENTION

### Description of the Related Art

In recent years, retailers have increased their customer data collection capabilities in order to better track customer behavior, segment their customer bases, and tailor their programs and offers to specific segments as a way to increase loyalty and capitalize on cross-sell and up-sell opportunities.

In retailing, demand forecasts are typically conducted for products or product categories at various levels of the product/location/time cube.

### SUMMARY OF THE INVENTION

The present inventors have recognized that conventional methods of forecasting do not forecast and track the demand of individual customers. Thus, conventional forecasts are only a broad indication of general demand.

The present inventors have also recognized that, in view of the data available and retailer demand, there is a potential for retailers to leverage emerging types of contextual information that enrich the data they have about their customers to develop customer-level sales forecasts by location and time period (e.g., forecast period could be based on year, season, month, day & week, depending on shopping frequency, and user context such as vacation, impending travel, upcoming personal, community or religious events, etc). The present invention thereby provides a whole new capability to retail marketing by permitting a retailer to individually target each customer based on relevant information associated with that individual.

In addition, once individual customer-level forecasts are established, a retailer can monitor customers' shopping behavior and be alerted to take actions when actual sales differ by a predetermined amount or fraction from the expected sales for a time period.

In view of the foregoing, and other, exemplary problems, drawbacks, and disadvantages of the conventional systems, it is an exemplary feature of the present invention to provide a method and system for creating customer-level demand forecasts for predetermined time periods.

In a first exemplary aspect of the present invention, to achieve the above features and objects, described herein is a method that includes accessing, from a database, retail data for past purchases of a customer at a retail entity; and generating, using a processor on a computer, at least one purchase forecasting model for a specific product for the customer.

In a second exemplary aspect of the present invention, also described herein is a method that includes accessing, from a database, retail data for past purchases of at least one customer at a retail entity; accessing contextual information associated with each of the at least one customer, the contextual information comprising data affecting purchases at the retail entity; and generating, using a processor on a computer, at least one purchase forecasting model for a specific product or product category for each of the at least one customer, using the past purchase retail data and the contextual information.

In a third exemplary aspect of the present invention, also described herein is a system including a database storing customer data, retail information, and contextual information relating to a store location and customers making purchases at the store location, the contextual data comprising at least one of: information reflecting conditions or events that influence retail purchases at the store location; and information of a personal nature associated with each of the customers making purchases at the store location and that provides a profile of personal aspects that influence retail purchases at the store location; and a processor configured to access data from the database, to analyze the data, to generate a forecast for each specific customer, and to generate an expected value over a time period for each specific customer based on the customer's forecast.

These features can allow retailers to leverage emerging types of contextual information that enrich the data they have about their customers to develop customer-level sales forecasts by location and time period.

These features can allow retailers to take appropriate marketing actions at an individual customer level or at an aggregate customer segment level by noting differences between the expected sales and the actual sales for a specific product or a product category over a time period. Marketing actions can pertain to that specific product or product category and specific customer. In addition, a root cause analysis can be conducted to understand why the expected sales deviated from the actual sales for that product or product category and, using the outcome of the root cause analysis, forecasts can be adjusted for other products or product categories and appropriate marketing actions can be taken for other products or product categories.

### BRIEF DESCRIPTION OF THE DRAWINGS

The foregoing and other purposes, aspects and advantages will be better understood from the following detailed description of exemplary embodiments of the invention with reference to the drawings, in which:

FIG. 1 illustrates an exemplary method 100 of creating and using a time based forecast for individual customers;

FIG. 2 illustrates a high level view 200 of an exemplary system for creating and using a time-based forecast as a marketing tool;

FIG. 3 illustrates an exemplary graphical representation 300 of an expected value versus the actual customer value over time, thereby possibly initiating a possible marketing action based upon whether the actual value is above or below the expected value;

FIG. 4 illustrates an exemplary system 400 used to implement the present invention;

FIG. 5 depicts a computer system 500, such as a cloud computing node, according to an embodiment of the present invention;

FIG. 6 depicts a cloud computing environment 600 according to an embodiment of the present invention; and

FIG. 7 depicts abstraction model layers 700 according to an embodiment of the present invention.

### DETAILED DESCRIPTION OF EXEMPLARY EMBODIMENTS OF THE INVENTION

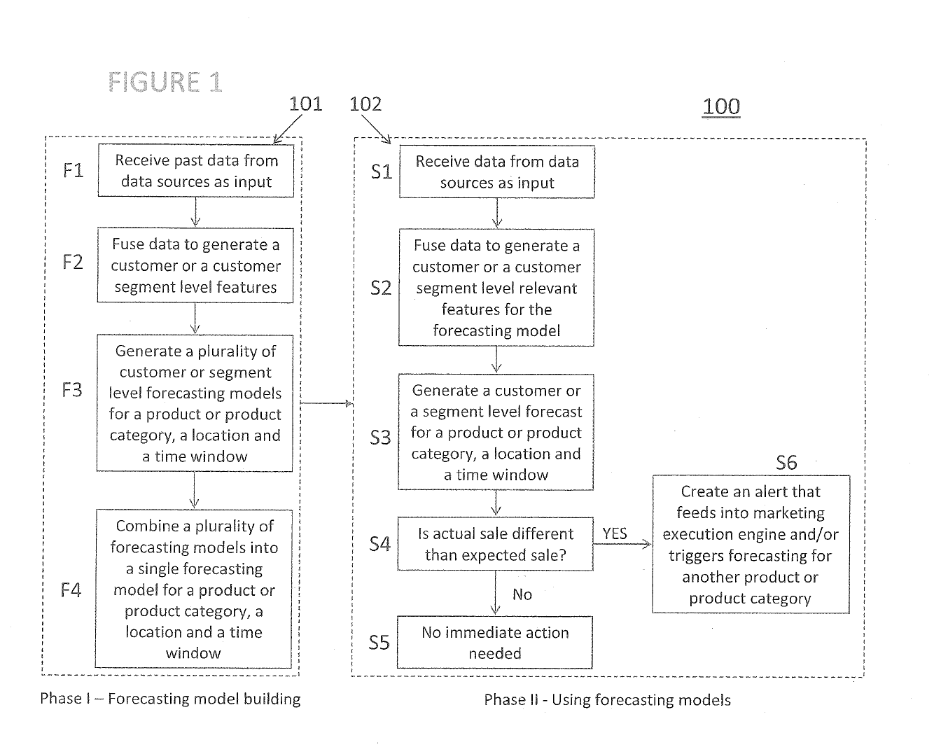

Referring now to the drawings, and more particularly to FIGS. 1-7, exemplary embodiments of the method and structures according to the present invention will now be described.

It should be understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

FIG. 1 illustrates an exemplary method 100 of creating and using a customer or a customer segment level forecast for a product or a product category, a location, and a time window, such as a week, month, or other appropriate time period. Conventional retail forecasting techniques have not reached the granularity of models that can be developed for each individual customer or specific customer segments, let alone a technique by which an individual might be induced to make additional purchases should his or her actual purchases be detected as falling short of the amount predicted by the individual's forecast for purchases. Nor has conventional retail forecasting developed a mechanism by which all kinds of external data, referred to herein as “contextual data”, can be ingested and analyzed such that contextual data possibly relevant to a specific customer or customer segment can be identified and used to improve models used for forecasts for a specific customer or specific customer segment over a given time period.

The method 100 consists of two phases, a first phase 101 of forecasting model building and a second phase 102 of using a forecast model generated for the individual customer or for a customer segment, a specific product, or a product category.

In the first phase 101, forecasting models can be built per product or product category, for a specific location and time window of interest. Model building can be performed on a periodic basis or triggered by the occurrence of an event, using, for example, any of a number of machine-learning algorithms.

For example, forecasting models for regular grocery needs can be built on a weekly basis. However, for an impending major storm event, a forecasting model building can be triggered a few days ahead of the storm. Also, the weather events may occur at different times depending on the location. So the time of model building can differ by location for the same broader impending event.

In the model building phase 101, past data from various sources of data is ingested, in step F1. The data sources might include, for example, retailer data sources, external data sources, geospatial data sources, temporal data sources, and contextual data sources.

The descriptive “contextual”, as used herein, is intended to refer to data sources outside the control of a retail entity and which data will permit insights into purchasing decisions by individual customers, by providing additional information, either additional information of external conditions or events in the area of a specific customer or additional information of a more personal nature that might be related to possible purchases by the individual customers at a retail entity.

It should be clear that, once available, information on external conditions, such as local weather predictions or local traffic conditions, or local events, such as local sporting events, would significantly improve modeling for retail purchases at any specific locality. Although “local” is used to describe such category of contextual data, it should be clear that events at higher levels, such as national or global holidays, or regional or state-wide events, might also be significant in influencing local retail purchases. Thus, the term “local” is intended to refer to events or conditions that potentially influence customers' purchases at any given local retailer location and does not necessarily imply that the condition or event is itself confined to the locality of that retailer location.

Concerning the second category of contextual data, it should also be clear that each individual customer has much information of a more personal nature that either consciously or unconsciously influence that individual's purchases at such retail entity. Knowledge of such personal information, if available, would also clearly permit improvement of retail forecasts for specific products for a specific customer or a specific customer or customer segment.

Some non-limiting examples of contextual data of the second type related to more personal information might include, for example, the individual's interest in specific sports or sport teams or events, hobbies and other interests, family events such as birthdays and anniversaries, composition of the individual's household, including indication of a spouse and/or children and/or pets. Additional examples would be the locations of the individual's residence and work, commute times and routing, travel and vacation plans, as well as ethnic preferences and holidays.

Thus, contextual data, whether related to local conditions/events or to customer-specific personal aspects, enriches the data that a retail entity has about their customers to permit customer-level forecasts by location and time period. Other examples are provided in discussions below that will further demonstrate how these various different data sources can directly provide information that is useful for a model, as well as being used to glean or infer additional information from various sources that can be used to construct models.

In order to permit forecasting directed to a specific individual, as including additional data related to different individual customers, in one exemplary embodiment, the present invention associates such contextual data with each specific customer. Such associations can be done, for example, by establishing a file in the retail entity's database for each individual or by merely making annotations in the database such that incoming contextual data can filtered and associated with as many specific individuals as would be appropriate.

Thus, for these two exemplary association mechanisms, in one approach the incoming contextual data is appropriately associated with one or more individuals as part of their profile in their respective contextual information files; in the other approach the incoming contextual data will be associated with a listing of appropriate specific individuals, and the individual's contextual profile will be constructed or augmented by collecting all contextual data items associated with that individual's identification. One of ordinary skill in the art would recognize that there could be other possible mechanisms to associate incoming contextual information with respective individuals, including hybrid versions of these two mechanisms and mechanisms based on tables or indexing.

Regardless of which mechanism is used to provide an association between incoming contextual data and specific individuals in the retailer's database of customers, such contextual data is developed from data from various possible sources so as to provide a profile of that individual as related to possible purchase models with the retail entity for one or more products available from the retail entity, as updated as more information of that individual becomes known. Different aspects or data of this profile data might be useful for developing different models, depending upon which specific product or product category is being modeled. Data for the individual's profile can be entered manually, or it can be automatically entered into appropriate individual profile files or other associative storage techniques as information updates are received through any number of possible electronic data sources, or it can be updated using both manual and automatic update mechanisms. The individual may also provide the profile data in response to emails, text messages, coupon clipping, calendar data, etc., and other forms of possible data that would be expected to evolve in the future.

Non-limiting examples of data sources for automatic updates to the profile stored in the individual profiles might include, for example, mobile apps that permit the individual to interact with the retail entity and RSS (Rich Site Summary) feeds, or equivalents such as Atom syndication format feeds, which use a family of standard web feed formats to publish frequently updated information and which can publish updated information from a website or can aggregate data from many sites. RSS files can be read both by automated processes as well as human users, so that RSS update data can be distributed as appropriate to individual profile files. Other examples of automatic data inputs include, for example, a number of apps and techniques which automatically report a current location of a user's mobile device. The present invention intends to include such automatic current location updates as a form of contextual information for that individual.

Association between incoming data and specific individuals can be direct, by reason that the incoming data has a specific individual's name or other identification. Examples of such direct association might include, for example, current location information coming from a user's mobile device, inputs provided by a customer using an app from the retail store, or reports of Internet activity from a customer's browser.

Other incoming data can be associated with one or more individuals indirectly, by reason that relevance can be inferred between the incoming data and specific individuals. For example, incoming traffic congestion reports can be associated with customers having residence or work addresses near the congested areas. Another example would be associating school lunch menu information with specific customers having children attending these schools.

Because of the different types of information in these different data sources, in order to develop different models, it is necessary to determine which feature from the various data sources would be important for specific models. Therefore, in step F2 of FIG. 1, this data can be used to extract a listing of potential customer or customer segment level features that are possibly relevant to a product or product category, location, and time window for which the forecasting model is being built. These features will become target features and input variable features of the different forecasting models.

A typical target feature might be a quantity that a customer purchased for a product or a product category and which, for a forecast model, will be predicted to purchase in the future. Input variable features are potential predictors of the target feature. Various non-limiting examples of predictors have been suggested above.

A few more examples are presented to illustrate target variables and input features. Consider an example where a household's weekly grocery spend on common grocery items is forecast. In this case, the target variable can be the dollar amount of the weekly spend by a customer on a set of items designated as common grocery items. The input features can consist of relatively static sources of information as well as dynamic sources.

Relatively static features can be the ones derived from the customer profile. Such static features are commonly used already in many forecasting model mechanisms. Examples of static features include the number of household members, the number of adults, the number of children, average age, average income, average age of children, and distance of the household from a store or competitor. Examples of dynamic features include weekly spends for past three weeks, weekly spends from last year around the same period, past two weeks weather information such as average temperature, humidity, rainfalls and snowfalls, other dynamic features such as holiday events.

Consider another example where a customer's spend on game snacks such as chips, salsa, beer, soft drinks timed around home-team games or major games is forecast. First, a set of customers who spend on game snacks timed around important game event is identified using correlations and customers' previous purchase histories. Then, the target feature in the forecasting model can be the dollar amount spent on the items associated with game snacks. The input features can be some of the above commonly used static features and dynamic features can be the customer's spend on previous such events, weather, the importance of the game in the tournament, etc.

Consider yet another example where a customer's spend before an impending snow storm event is forecast. Many families with children rely on school meal plans and plan their weekly spend accordingly. However, due to extreme weather events such as snow storms, schools are often closed and families may need to stock up. While building a forecasting model for spends before impending event, the target variable can be the dollar amount on typical grocery items a day or two before the event. The dynamic input feature set can be made of most recent spend amount, spend before previous few extreme events, weather during that situation, weather parameters for the impending event, alert levels, etc.

Using the target and input features, in step F3 of FIG. 1, a plurality of forecasting models are built for a product or a product category, a location, and a time window. A plurality of forecasting models can be built using existing machine learning based methods and/or time-series forecasting methods, and using the standard training-testing-validation methods. In an exemplary embodiment, only the highest quality models with high quality (high accuracy, precision, recall, etc.) are retained.

Thus, once a target variable and a feature set is available, a number of standard time series and machine learning techniques can be applied to build a forecasting model. Examples include, autoregressive moving average (AMA), autoregressive integrated moving average (ARIMA) model, logistic regression, support vector machine, regression trees, random forest, etc. Depending on the performance of the model, one or multiple of these models can be simultaneously run. Each model has an associated confidence level or weight at the predicted output. This can be used to combine the outcome of different models. In the machine learning art, this technique is also known as the “ensemble method.” The combining criteria for ensembles can be voting, confidence weighted voting, or averaging.

The learning algorithms will detect how much spending can be expected to change due to an upcoming anniversary or birthday party, or how much spending can decrease due to being away on vacation, or how much consumption will change due to an upcoming storm, and build this into the model parameters.

In step F4, the plurality of retained forecasting models can be combined into a single model for the product or the product category, the location, and the time window and is stored for future uses. Thus, a model could be developed for a single individual, or, a generic model at a user segment level or a product category level could be developed and then refined for the individual using, for example, contextual data relevant to that individual.

The combining methods can also include assigning weights to each of the models and combining outputs of different models using such weights. Weights assigned to each model can be based on the confidence measures that are generated by involved machine learning methods or quality measures of the model such as accuracy and precision. Combining weights of different models may be based on ranking or rules or combination, which itself can be learned. A final single forecasting model is then used in the second phase 102 shown in FIG. 1.

In this second phase 102, various sources of data sources are entered into a forecasting engine, in step S1. As previously mentioned, the data sources can include retailer data sources, external data sources, geospatial data sources, temporal data sources, and other contextual data sources.

Retailer data might include, for example, past purchase records of each individual customer, as might be stored in a retail entity database in a format of n-tuples such as [CustID, StoreID, PointOfSaleUnitID, Date/Time Stamp, SKU₀, SKU₁, SKU₂, . . . SKU_{N}] and that record all purchase transactions made by individual customers at specific checkout locations at a retail entity and at specific times and dates. The term “SKU” refers to a Stock Keeping Unit, and is a unique identifier for each distinct product and service that can be purchased in business. In addition to the SKU identification number itself, the SKU information could also include additional information related to quantity, pricing, attributes (technical, functional, and emotional attributes), etc., for that SKU item in that transaction. This purchase history data might also be used in first phase step F1.

Additional retailer data might include such additional data as pharmacy information for each customer, if the retail entity provides pharmacy services. Such pharmacy information could be stored in a file under the customer's identification, and this customer file might include additional retail data for this customer, such as loyalty card data for that customer, shopper check-in events, shopper e-commerce engagement events and browser history for that customer.

This use of contextual data, particularly contextual personal data, and of generating forecasts for individual customers are considered novel aspects of the present invention, since, first, retail forecasting has conventionally been directed to products, product categories, and local market locations and has not been directed toward forecasts of specific individuals. Second, by providing personal profile information for each individual and/or local conditions/events, the present invention provides a novel mechanism for making forecasts for individual customers, as potentially being much more precise because of this additional contextual information.

External data sources are data sources providing data possibly related to a specific retail entity location, as arriving from sources outside the retail entity and its database. Thus, if the retail entity is a national chain store, the external data sources would be sources of data related to those stores located, for example, in a specific city or county. For purpose of explaining the present invention, the external data sources can be considered to be external data related to the local retail stores, as stored in a database related to those local retail stores, and as possibly related to individual customers of those local retail stores. This concept of using external data sources as potential data in forecasting models for individual customers is also considered a novel aspect of the present invention.

Examples of possible external geospatial, temporal, and contextual data sources might include such data as:
shopper location traces, as might be reported, for example via FourSquare, a mobile app that reports location, via shopper checkins, or via shopper commute data;
local event calendar data, such as dates for local sports teams, local school lunch menu data, etc.;
shoppers' personal calendar data, such as travel dates, indications of working at home, etc.;
shoppers' health and fitness conditions, potentially monitored by medical or wearable sensors;
local weather data, such as forecasts for storms, rain, heat waves, cold snaps, allergy alerts, etc.;
traffic levels for the time window of the forecast model, including such local traffic conditions for special events or periodic traffic jams during rush hours;
traffic patterns, including predicted or actual changes to local traffic patterns due to planned construction projects or accidents;
competitive presence and proximity, including, for example, data obtained from competing retail entities that provide web-based store locator features that permit consumers to locate stores in specific areas; and
competitor strategy and actions related to products, pricing, marketing, promotions, advertising, etc.

This data is used to generate, in step S2, a set of features relevant to the forecasting model associated with a product or product category, a location, and a time window. These feature values are used with the forecasting model to generate, in step S3, the forecasts at a customer or a customer segment level for the product or the product category, location and time window. In some exemplary embodiments, the forecasts can then be combined into a single forecast (e.g., a triangulated forecast which averages forecasts and/or fills in gaps that one model might have) of expected spending value for the customer over a time period.

In step S4, the actual sales for the product or the product category are compared to the expected sales. If the actual value does not deviate from the expected value by a certain amount, then no action is required, as shown in step S5.

On the other hand, if the actual value deviates from the forecast by a predetermined amount or fraction, an alert is fed in step S6 into the marketing execution engine and/or a trigger is generated to calculate the forecast for another product or product category.

The marketing engine may recommend an action that includes an incentive or a reward, which can be sent by a third party or the retailer, depending on what party is conducting the data analysis and tracking. Examples of incentives might include discount coupons or vouchers to be applied towards the products or product categories for which the gap between the expected and actual value is realized, or the products or product categories associated with the future expected value. An example of a reward might include discount offers towards future purchases. Besides the alert to the marketing execution engine, a trigger may be sent to calculate forecasts for another product or a product category that is known to be associated with the current set of values of input features, as discovered through root cause analysis. This is further explained in detail later.

Exemplary mechanisms for mining data and developing retail customer forecasting models for individual customers will now be explained, as starting out with the past purchase history stored by a retail entity in a purchase database in, for example, n-tuple format such as [CustID, StoreID, PointOfSaleUnitID, Date/Time Stamp, SKU₀, SKU₁, SKU₂, . . . SKU_{N}]. The actual database used for implementing the prototype of the present invention included a retail entity database having data for over 300,000 customers. The retail entity purchase database would also likely include other types of information, such as contact information for customers, resident addresses, work address, etc., plus possibly other information such as marital and familial data for at least some of the customers.

With such purchase event data, it should be clear that the present invention would be able to develop a historical purchase model for each article purchased by each customer, with the goal of determining whether there is a repetitive pattern for each such purchase. With such repetitive purchase pattern information, a forecasting model could easily then be developed that would forecast when each customer would be predicted to make another purchase of that article.

It should also be clear that forecasting models could be merged together to provide a forecasting model for each article for all customers. It should also be clear that forecasting models of more than one article could be lumped together to provide forecasting models for different product groupings over the customer base.

Although this explanation of model development was based on individual customers, it should also be clear that models could developed based on other approaches, such as a purchase history for individual articles in the inventory, which could then be merged into models for product groupings, including forecasting models for such articles and product groupings.

Although the above explanation for model development demonstrates how forecasting models can be developed from retail entity data, the present invention adds more complexity and depth to these models by including additional data related to such external events, including, for example, data for local events and national holidays, local weather data, local and national sports event data, as examples of contextual data. Thus, a forecasting model could easily be developed by a retail entity for different product clusters for an upcoming sports event or for a predicted local weather event. Additionally, forecasts for each individual customer could be generated for each holiday, weather, or sports event, either based on previous purchases of that customer for those events or based upon placing the customer into a category of other customers for such events.

Additional depth for the retail models can be achieved by focusing on models for each customer or customer category, taking into account such information as marital and family data, birthday and anniversary data, and individual interests and consumer preferences demonstrated by their purchase history. For example, if a customer is classified as a parent with children of particular ages, then purchases can be forecast for that customer based on classifying that customer in a model developed for a parent with children of similar ages.

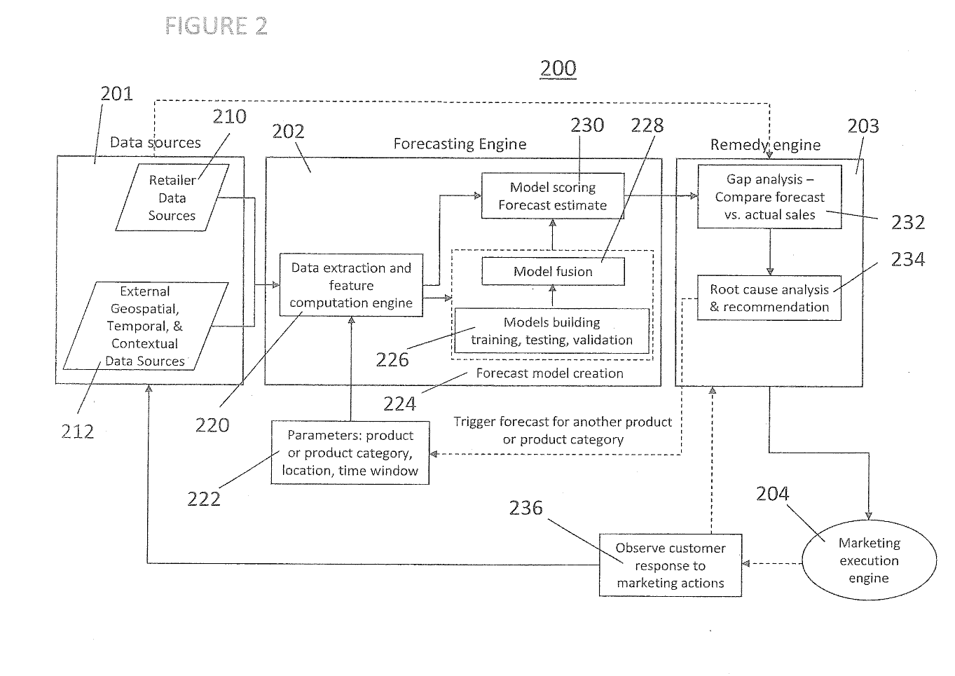

FIG. 2 illustrates a high level view of an exemplary system 200 for creating and using customer forecasts, from the perspective of software modules being executed on one or more computers. Data source module 201 accesses and sends retailer data 210 and other data 212 to a processing system 202. The processing system modules include a forecasting engine 202 to create high quality forecasts at a customer level or a customer segment level for a product or a product category, a location, and a time window.

The forecasting engine 202 can include a data extraction and feature generation engine 220 that can ingest the retail data 210 and other external spatio-temporal contextual data 212. This forecasting engine 202 also accepts other input parameters 222, such as a product or a product category, location, and time window of interest, for specific forecasting instances. The forecasting engine 202 uses these parameters and input data to generate customer level features or customer segment level features which include a target variable for forecasting and input variables, based on, for example, customer profile and purchasing history, product demand forecast by location, and other contextual data effects on customer spending, as will be shortly demonstrated in several examples.

The processing system forecasting engine 202 can also include a forecasting model building engine 224 and a forecast calculation engine 226. In the model building stage, target and input features based on a customer or a customer segment's past data are used to train, test, and validate different types of forecasting models using machine learning and/or time series forecasting based approaches. Individual models are retained depending on the performance. The output of plurality of these retained models can then be fused into a single model 228. The fusion can be based on a rule-based approach or by assigning weights to individual model and combining those using ranking or combination techniques.

In the model usage phase 102 of FIG. 1, based on recent data, only input features at a customer or a customer segment level are computed and used with the forecasting model to estimate the forecast, which is the output from the Model Scoring and Forecast Estimate engine 230 of the forecasting engine 202.

Processing system 202 sends the forecast output to processing system remedy engine 203. The remedy engine 203 ingests input from data sources 201, in particular, recent retail data about a customer or a customer segment's shopping behavior, and compares the forecast estimate for a product or a product category with the actual sales, thereby performing a gap analysis in module 232. Based on a deviation between the expected forecast sales and actual sales of the customer or the segment over a time period, the remedy/recommendation engine 203 can send a prompt to the root cause analysis and recommendation module 234, where a root cause analysis is conducted, based on the retailer data and other contextual information, to find if a gap exists because of causes that may impact sales in other areas. The root cause analysis 234 can be based upon determining whether another model would provide a better estimated forecast. For example, a model developed for another product might provide a better estimation for the gap that is observed between forecast and actual purchase amounts.

Accordingly, in some instances, a forecast computation is triggered for another product or product category, location, and time period, using a feedback signal to parameters module 222. In addition, the remedy/recommendation module 203 may issue an incentive or reward to the marketing execution engine 204, which response is monitored in module 236.

The data source module 201, processor module 202, processor module 203, and marketing execution engine 204 can each be included in a single system, or can be distributed over any number of systems. Similarly, the individual engines and data sources can utilize the same memory and processor, if desired.

The retail data sources are not particularly limited. For example, the retail data sources can include transaction data (e.g., past purchases, pharmacy info), market basket data, loyalty card data, shopper check-ins, shopper e-commerce engagement and browser history.

The external, geospatial, temporal, and contextual data sources 212 are not particularly limited and can include data from shopper location traces (e.g., mobile app location check-ins, commute data, local event calendars, etc.), local sports teams, school lunch menus, personal calendars, (e.g., travel, work at home indication, etc.), weather, (e.g., storms, rain, heat wave, cold snaps, allergy), shopper demographics, shopper social media posts, traffic levels, traffic patterns, competitive presence and proximity, competitor strategy and actions related to products, pricing, marketing, promotions, advertising, etc.

The present invention thus recognizes that there is potentially a large amount of data available to a retail organization concerning individual customers, potential customers, and consumer segments from any number of potential data sources, and that additional information can be gleaned if information from such sources is further analyzed for specific individuals such as to build up a profile for that individual as potentially related to the retail organization.

In an exemplary embodiment, a first type of sales forecast will leverage existing retailer data about customer profiles and historical purchasing behavior, a second type of demand forecast will leverage existing retailer intelligence about overall product demand by location and time period, and a third sales forecast will bring in new data sources about an individual customer's context.

In an exemplary embodiment, each type of the forecast leveraging a particular set of data sources can be built using any of various machine learning based approaches already well known in the art, such as linear regression, support vector regression, logistic regression, regression trees, or even ensemble learning methods which make use of more than one of these approaches.

As is also well known in the art, each of these forecasting models can be trained against a fraction of past data including transaction, and customer data and the accuracy of the forecast can be tested against the remaining fraction of past data. In an exemplary embodiment, ensemble learning can be used to combine multiple forecasting model outputs into one model where each model's output can be assigned a weight depending upon its confidence in the output and the combination into a single output is based on the linear weighted combination. In an exemplary embodiment, these forecasts can then be further combined to create a new forecast, sometimes referred to as a “triangulated forecast.”

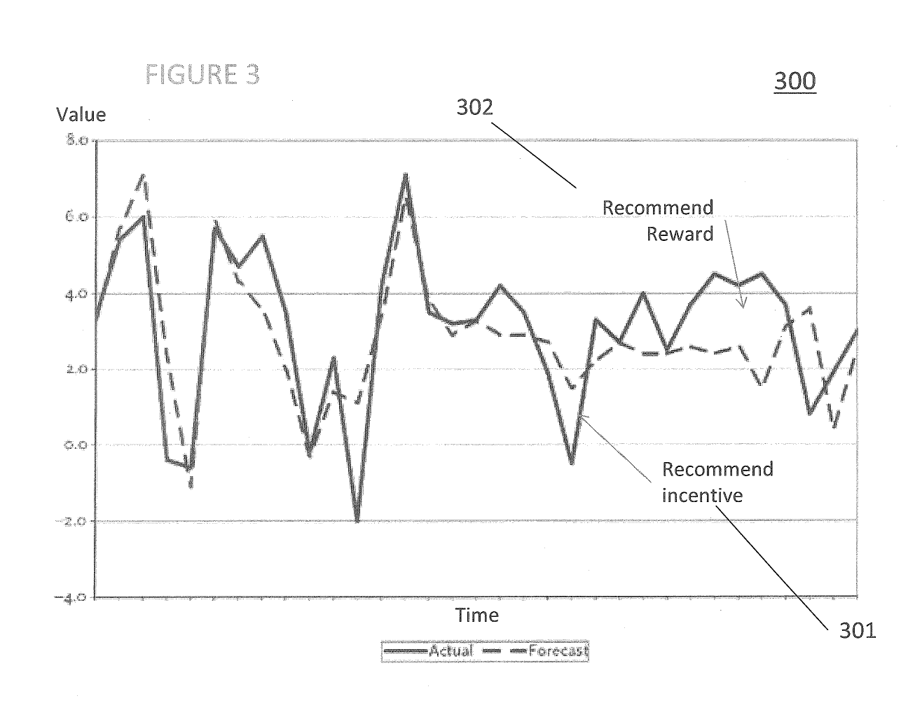

The deviation triggers may also vary. For instance, if there is a certain shortfall (e.g., two percent under forecast) the customer may automatically be sent a marketing offer to their cell phone, based on a signal from the marketing execution engine 204. If the customer has spent more than their expected value, then the customer may be sent some kind of reward. FIG. 3 exemplarily shows these two possible marketing mechanisms 301, 302.

Examples of how retailer information and other contextual information can be combined will now be discussed.

In a first example, a profile has been developed for customer X indicating that he is an avid football game follower, loves his home team, and regularly hosts game watching parties at home, and buys chips-salsa and beverages from the local grocery store A. The system 200 can automatically develop a model that includes these aspects of customer X for these products by pulling up X's demographics information from his personal profile data file and correlating his purchases with the external events calendar and, based on his age, can thereby infer that his purchase behavior habits are closely tied with a football game involving his favorite home team. The system 200 automatically develops a forecasting model capturing this behavior based on the game calendar of the home team. The system 200 will also update the personal profile data file to identify this new personal information that was inferred by correlating purchasing history with external events.

The system 200 then notices that in a recent month, customer X has not purchased his regular party stuff at store A in the last two weeks even though there were games involving his home team. Timed before an upcoming home team game, the system 200 suggests that store A send discount coupons on chips-salsa and beverages. Customer X responds to these coupons and buys these products from store A, presumably based upon the timely enticement generated by system 200.

In another example, customer X's profile data file information indicates that she is a mother with three kids. Based on the demographics and average household consumption of typical grocery items, the system 200 infers that the kids go to school and are part of the meal plan in the school. During unusual cold winters, schools are often closed due to snow days and kids are at home.

By tying past severe weather information, school calendar, and customer X's purchase history, the system 200 notices an increase in grocery purchases a day before impending snow storms. Based on this observation, the system 200 model creation module 224 automatically builds a forecasting model at customer X's level to include these features for specific products. Based on this forecasting model, the system 200 can design incentives and rewards based on the expected and actual sales for customer X that take into account predicted weather events and specific products discovered as useful during such weather events.

As yet another example of the use of an exemplary forecasting system 200, assume that customer X shops at the store A nearly every day. The profile for customer X suggests that she is a foodie, meaning that her profile indicates that her purchases tend to distort to fresh items, international foods, and wine. She purchases little else from store A. That is, she has purchased no paper products, no prepared foods, little deli or dairy, just one cup of coffee at Starbucks in the past year, and zero gasoline.

Clearly, from her spending profile, a competitor is getting a large portion of her potential store A spending. Store A's goal may be to engage more effectively with customer X to protect the current business with her and to increase her average basket size (amount spent in a trip) via relevant and timely marketing campaigns, if a profile can be generated that would reflect her expected expenditure trends.

In this example, the system 200 might pull household demographic and behavior information from existing store A customer databases and combine this data with new data sources, such as transaction dates and times of day, local weather, seasonality, consumption rates for each item in customer X's purchase history, nearby competitors and their proximity to customer X's home, competitor product offerings, current pricing promotions, advertising, and local events. The system 200 fuses all these data, calculates a weekly expected value (EV) for customer X's purchases at store A and monitors her spending trends as each week progresses. An exemplary visual illustration of this spending trend 300 is shown in FIG. 3.

At mid-week, the system detects that customer X's purchasing has dipped below expectations and she is at risk of not fulfilling her EV. This deviation triggers a marketing action to avert a potential shortfall in her weekly spend. The marketing application sends customer X a text message 301 containing a special deal on her favorite wine for this week only. Customer X redeems the offer on the next day and picks up some additional unexpected items, putting her back on track. Customer X later exceeds the EV and thus receives a loyalty reward coupon 302. Note that the additional purchases provide additional information for customer X's profile data file, including feedback about her possible future purchases relative to other customer profiles at store A.

It is noted that the plurality of forecasts, and therefore the combined forecast, can take into consideration the contextual information known about the customer, such as if the customer is out of town, if they do not shop when it rains, etc., to adjust the EV forecasts. Such contextual information might be available by noting, for example, when the customer makes an online airline ticket purchase or checking the customer's purchase record relative to local weather events.

In addition to providing a means to activate targeted marketing, these examples demonstrate how an exemplary embodiment of the invention can also provide a mechanism for retailers to analyze, evaluate, and engage individual customers, thereby improving chances for delivering a more positive customer experience and building increased loyalty to a retailer.

An exemplary embodiment may also include conducting a root-cause analysis by considering other contextual information if the expected value deviates from the actual customer value more than a certain amount in certain areas. For example, the system 200 may note purchases of the pharmaceutical products in the grocery purchases and may thereby infer that a child in the household is sick and may realize that there may be a gap between the expected and actual value in certain product areas. The system 200 can adjust forecast in other product areas and recommend appropriate marketing action in new relevant product categories based, for example, on the specific pharmaceutical products that had been purchased.

An exemplary embodiment of the system 200 can also increase management visibility to specific opportunities for increasing a customer's basket size (amount purchased), shopping frequency, and customer satisfaction. This system 200 can also increase management visibility to problems customers may be encountering in the shopping process so they can develop improvement programs as appropriate.

An exemplary embodiment may also include the system 200 noting that customers are not responding to the incentives provided based on the gaps between the actual and expected value, and recommending retailers specific actions. These may include suggestions on readjusting inventory levels or providing deeper incentives or a richer inventory.

Exemplary embodiments of the above system 200 can also enhance the productivity of marketing and loyalty programs by providing greater precision and forecast accuracy. The system 200 can also enhance the return on marketing spend by surgically placing investments with customers who will yield the maximum return.

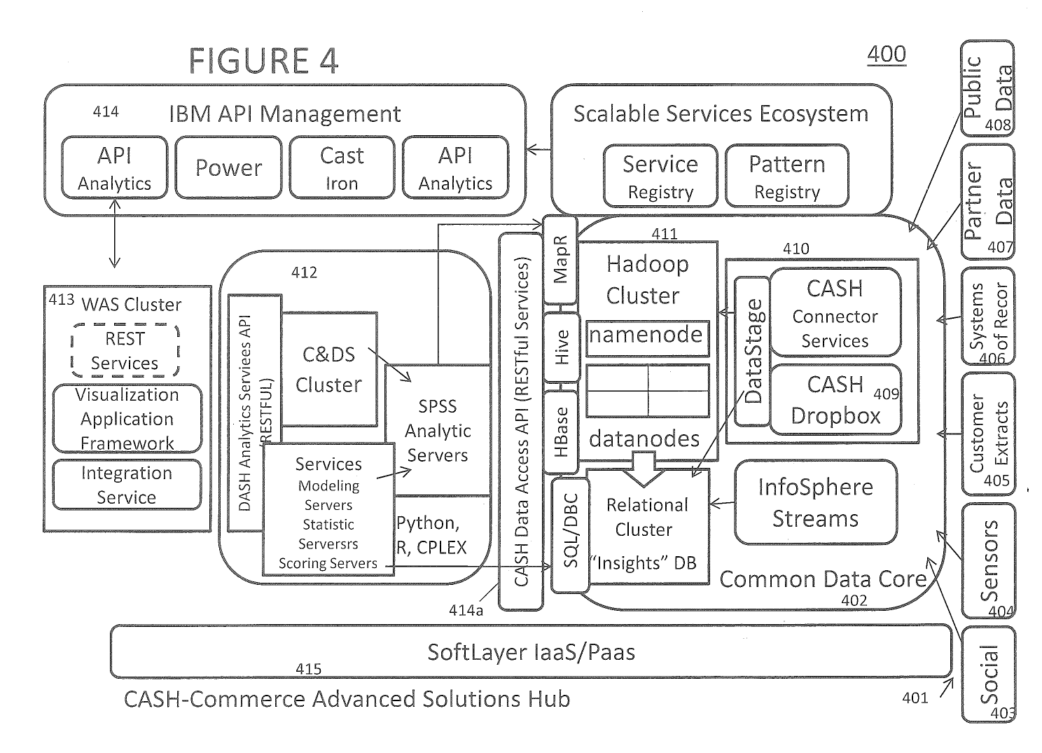

FIG. 4 shows an embodiment of the architecture of computing resources that can be used to implement the analytics pipeline in the present invention. Inputs 401, shown on the right side of the figure, provide data that is collected in a data input stage 402. As exemplary examples discussed previously, the input data could come from social media 403, such as Twitter, Facebook and local news media, or sensors 404, such as positional or biometric sensors, received as streaming data. Addition data arrives as customer extracts 405, such as customer profile data, loyalty card data, and coupon redemption history and which is received by a software product like IBM Dropbox 409. Systems of records 406, such as retailer purchase history, point of sale transaction data and available inventory records, partner data 407, such as customer data and survey data depending upon retailer's partnerships with other businesses, and public data 408, such as publically available RSS feeds, are received by connector services 410 which pull data from different input services. The connector services contain a range of components to be able to pull or accept data from different data sources.

Hadoop cluster 411 is a cluster of community hardware used for large scale storage and processing of data sets, both as structured and/or unstructured data. Additionally traditional relational database tools such as IBM DB2 are also used to store structured data. The analytics engine 412 exemplarily comprises clusters of servers used to filter and analyze the input data and includes data processing and predictive modeling software such as IBM SPSS Modeler, deployment platforms such as IBM SPSS Collaboration and Deployment Services, and optimization software such as CPLEX for various types of mathematical optimizations, including very large integer programming problems.

IBM Websphere Application Server (IBM WAS) cluster 413 provides the middleware to support a range of web services. The API Management modules 414 provide control management functions for the analytic engine 412 as well as user interface, so that a user can interface with the system 400 to generate forecasts for different customers and monitor customer purchases relative to the forecasts.

SoftLayer Infrastructure as a Service (IaaS)/Platform as a Service (PaaS) 415 is an IBM product that provides an interface for cloud services.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Turning now the possible hardware implementations that would support the methods of the present invention, it is previously noted that the invention could be supported with most computer architectures, including a cloud-based architecture. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

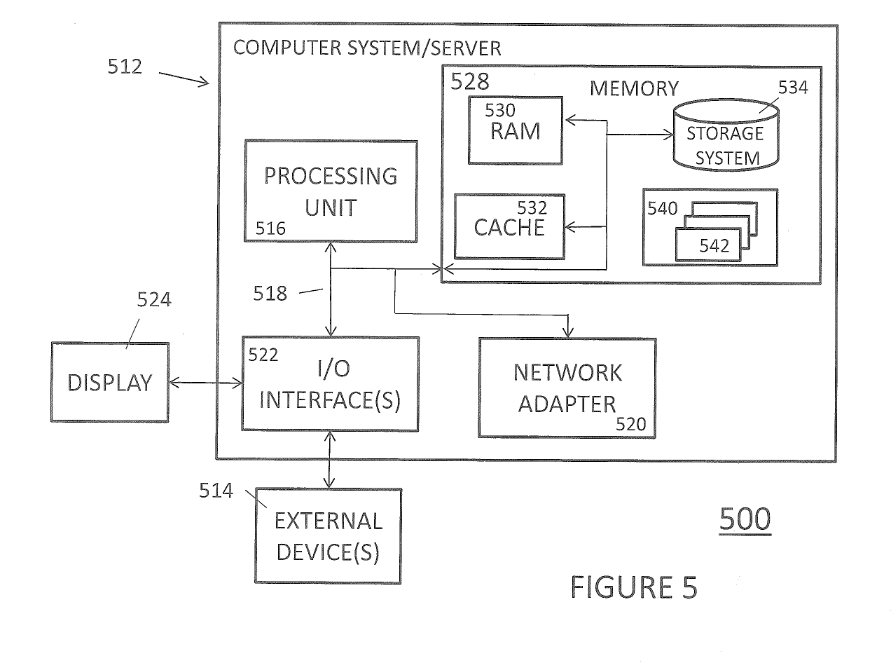

A cloud computing environment is service oriented with a focus on statelessness, low coupling, modularity, and semantic interoperability. At the heart of cloud computing is an infrastructure comprising a network of interconnected nodes. Referring now to FIG. 5 a schematic of an example of a cloud computing node 500 is shown. Cloud computing node 500 is only one example of a suitable cloud computing node and is not intended to suggest any limitation as to the scope of use or functionality of embodiments of the invention described herein. Regardless, cloud computing node 400 is capable of being implemented and/or performing any of the functionality set forth hereinabove.

In cloud computing node 500 there is a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 512 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 512 in cloud computing node 500 is shown in the form of a general-purpose computing device. The components of computer system/server 512 may include, but are not limited to, one or more processors or processing units 516, a system memory 528, and a bus 518 that couples various system components including system memory 528 to processor 516. Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 512 typically includes a variety of computer system readable media. Such media may be any available media that is accessible by computer system/server 512, and it includes both volatile and non-volatile media, removable and non-removable media. System memory 528 can include computer system readable media in the form of volatile memory, such as random access memory (RAM) 530 and/or cache memory 532. Computer system/server 512 may further include other removable/non-removable, volatile/non-volatile computer system storage media.

By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein.

Computer system/server 512 may also communicate with one or more external devices 514 such as a keyboard, a pointing device, a display 524, etc.; one or more devices that enable a user to interact with computer system/server 512; and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems, etc.

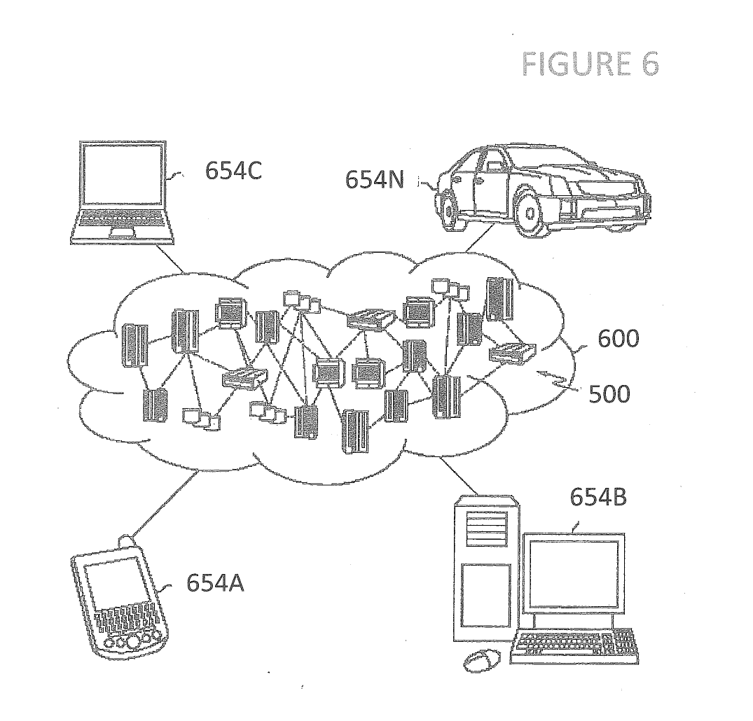

Referring now to FIG. 6, illustrative cloud computing environment 600 is depicted. As shown, cloud computing environment 600 comprises one or more cloud computing nodes 500 with which local computing devices used by cloud consumers, such as, for example, personal digital assistant (PDA) or cellular telephone 654A, desktop computer 654B, laptop computer 654C, and/or automobile computer system 654N may communicate. Nodes 500 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device.

It is understood that the types of computing devices 654A-N shown in FIG. 6 are intended to be illustrative only and that computing nodes 500 and cloud computing environment 600 can communicate with any type of computerized device over any type of network and/or network addressable connection (e.g., using a web browser).

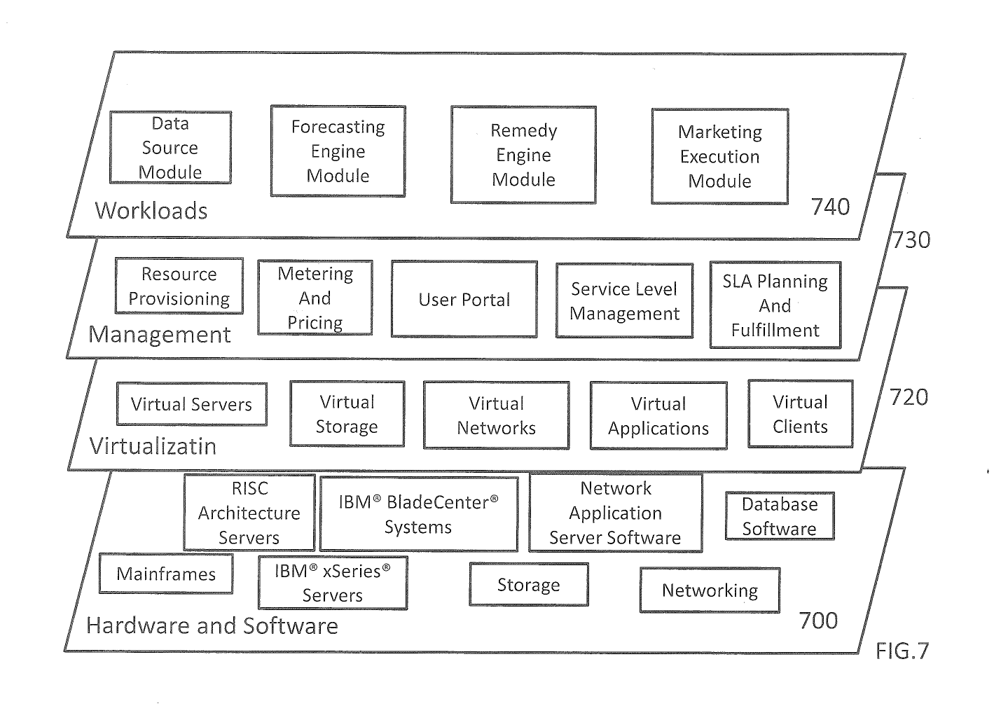

Referring now to FIG. 7, a set of functional abstraction layers provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided.

Hardware and software layer 600 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 720 provides an abstraction layer from which the following examples of virtual entities may be provided: virtual servers; virtual storage; virtual networks, including virtual private networks; virtual applications and operating systems; and virtual clients.

In one example, management layer 740 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 760 provides examples of functionality for which the cloud computing environment may be utilized to implement the present invention. Examples of workloads and functions which may be provided from this layer include the implementation of the data source module 201, the forecasting engine module 202, the remedy engine module 203, and the marketing execution module 204, as exemplarily shown in FIG. 2.

While the invention has been described in terms of exemplary embodiments, those skilled in the art will recognize that the invention can be practiced with modification within the spirit and scope of the appended claims.

Further, it is noted that Applicants' intent is to encompass equivalents of all claim elements, even if amended later during prosecution.

Having thus described our invention, what we claim as new and desire to secure by Letters Patent is as follows:

1. A method, comprising:
accessing, from a database, retail data for past purchases of a customer at a retail entity; and
generating, using a processor on a computer, at least one purchase forecasting model for a specific product for said customer.

2. The method according to claim 1, wherein said at least one purchase forecasting model is for a specified time period, said method further comprising generating, for each of said at least one purchase forecasting model, an expected sales value over said specified time period for said customer and said specific product.

3. The method according to claim 1, further comprising accessing contextual data related to local events and conditions at a store location used by said customer, wherein at least one of said at least one purchase forecasting model is based at least in part on said local events and conditions data.

4. The method according to claim 1, further comprising accessing contextual data information associated with said customer, said contextual information comprising data of a personal nature that provides a profile of personal aspects affecting purchases at said retail entity, wherein at least one of said at least one purchase forecasting model is based at least in part on said contextual data information for said customer.

5. The method according to claim 2, further comprising:
monitoring purchasing events of said customer at said retail entity over at least a portion of said specified time period; and
comparing said purchasing events with said expected sales value for said specific product.

6. The method according to claim 1, wherein said generating at least one purchase forecasting model for said specific product for said customer comprises developing a plurality of models for said customer, for a plurality of products, said method further comprising merging said plurality of models into a single model, to thereby develop a product category model for said customer.

7. The method according to claim 1, further comprising:
developing a forecasting model for said product for a plurality of customers; and
merging said plurality of models into a single model, to thereby develop a product model for a customer segment.

8. The method according to claim 1, wherein the forecast model building is exercised based on a specific time schedule or trigged by an event.

9. The method according to claim 1, wherein a plurality of forecasting models are developed, said method further comprising combining the plurality of forecasting models into a single forecasting model.

10. The method according to claim 9, where the plurality of forecasting models are combined into a single model by assigning weights to outputs of individual forecasting models and a final output is generated based on a combination of weighted outputs of the individual forecasting models.

11. The method according to claim 5, wherein a plurality of models are developed for said product for said customer, said method further comprising:
computing a difference between actual and expected sales for a customer for said product, a location and a time window; and
at least one of:
triggering a root cause analysis if an expected sales value deviates from an actual sales value by at least a predetermined amount, said root cause analysis comprising determining whether another of said plurality of forecasting models more accurately reflects said difference, and, if another forecasting model is determined as being more accurate for said difference, triggering a forecast computation for another product or a product category; and
transmitting a marketing event to said customer.

12. The method according to claim 11, wherein, if an actual customer sale is less than the expected sale, then the marketing event transmitted to said customer comprises an incentive.

13. The method according to claim 11, wherein, if an actual customer sale is greater than the expected sale, then the marketing event transmitted to said customer comprises a reward.

14. The method according to claim 1, as tangibly embodied in a set of computer-readable instructions on a non-transitory storage medium.

15. A method, comprising:
accessing, from a database, retail data for past purchases of at least one customer at a retail entity;
accessing contextual information associated with each said at least one customer, said contextual information comprising data affecting purchases at said retail entity; and
generating, using a processor on a computer, at least one purchase forecasting model for a specific product or product category for each said at least one customer, using said past purchase retail data and said contextual information.

16. The method according to claim 15, wherein said contextual information comprises at least one of:
information reflecting conditions or events that influence retail purchases at a local retail store of said retail entity; and
information of a personal nature associated with each said at least one customer that provides a profile of personal aspects that influence retail purchases at the local retail store.

17. The method according to claim 15, wherein a purchase forecasting model for a specific product or product category for each of a plurality of said customers is generated, said method further comprising merging said purchase forecasting models into a single model, to thereby develop a product model or product category model for a customer segment.

18. The method according to claim 15, wherein said at least one purchase forecasting model is for a specified time period, said method further comprising:
generating, for each of said at least one purchase forecasting model, an expected sales value over said specified time period for each said customer and each said specific product or product category;
monitoring purchasing events of each said customer over at least a portion of said specified time period for said specify product or product category;
comparing said purchasing events with said expected sales value for said specific product or product category;
determining whether a difference exists between said purchasing events of said product or product category and said expected sales value that exceeds a predetermined amount; and
transmitting a marketing event to said customer if said difference exceeds said predetermined amount.

19. A system, comprising:
a database storing customer data, retail information, and contextual information relating to a store location and customers making purchases at said store location, said contextual information comprising at least one of:
information reflecting conditions or events that influence retail purchases at said store location; and
information of a personal nature associated with each of said customers making purchases at said store location and that provides a profile of personal aspects that influence retail purchases at the store location; and
a processor configured to access data from the database, to analyze the data, to generate a forecast for each specific customer, and to generate an expected value over a time period for each specific customer based on the customer's forecast.

20. The system according to claim 19, wherein the processor further transmits a marketing event to any of a specific customer when an actual value of said specific customer deviates from the expected value of said specific customer by a predetermined amount.
